(19) United States
(12) Patent Application Publication
(10) Pub. No.: US 2010/0173172 A1
(43) Pub. Date: Jul. 8, 2010

(54) WEAR-RESISTANT COATING SYSTEM AND METHOD

(75) Inventors: Michael Lee Killian, Troy, MI (US); Aquil Ahmad, Farmington Hills, MI (US); Clifton Higdon, Birmingham, MI (US)

Correspondence Address: Quinn Law Group, PLLC, 39555 Orchard Hill Place, Suite 520, Novi, MI, 48375, US

(73) Assignee: Eaton Corporation, Cleveland, OH (US)

(21) Appl. No.: 12/684,241

(22) Filed: Jan. 8, 2010

Related U.S. Application Data
(60) Provisional application No. 61/143,186, filed on Jan. 8, 2009.

(51) Int. Cl. B32B 15/18; B32B 15/01; C21D 7/08; B05D 3/00

(52) U.S. Cl. 428/684; 428/615; 428/668; 428/681; 29/90.01; 427/532

(57) ABSTRACT

A method of forming a wear-resistant coating on a metal substrate includes depositing a metal alloy onto the metal substrate to form a cladding, rough finishing the cladding to thereby provide the cladding with an average roughness, Rₐ, of from about 50 micro-inches to about 150 micro-inches, and work hardening the cladding to thereby form the wear-resistant coating and a hardened zone thereof, wherein the hardened zone has a hardness greater than a hardness of the metal substrate. A wear-resistant coating system includes the metal substrate and the wear-resistant coating disposed on the metal substrate. The wear-resistant coating is substantially resistant to corrosion from sea water at an ambient temperature of from about −40° C. to about 50° C.

### CROSS-REFERENCE TO RELATED APPLICATIONS

This application claims priority to United States Provisional Patent Application No. 61/143,186, which was filed on Jan. 8, 2009.

### TECHNICAL FIELD

The present invention generally relates to wear-resistant coating systems and methods of forming a wear-resistant coating on a metal substrate.

### BACKGROUND OF THE INVENTION

Offshore drilling rigs often include direct-acting tensioners to compensate for wave-induced motion. More specifically, the direct-acting tensioners may include massive hydraulic cylinders that continuously dampen wave-induced motion and thereby balance the drilling rig.

The hydraulic cylinders are generally mounted below a deck of the drilling rig, i.e., in a splash zone, and are therefore often exposed to an extremely corrosive and wear-inducing environment from airborne salt spray, sea water, ice, moving cables, and/or debris. Additionally, the hydraulic cylinders may undergo thousands of wear-inducing displacements and rub against multiple hydraulic cylinder seals over a service life. Consequently, such hydraulic cylinders must exhibit excellent hardness, wear-resistance, and corrosion-resistance.

### SUMMARY OF THE INVENTION

A method of forming a wear-resistant coating on a metal substrate includes depositing a metal alloy onto the metal substrate to form a cladding, and rough finishing the cladding to thereby provide the cladding with an average roughness, Rₐ, of from about 50 micro-inches to about 150 micro-inches. The method further includes work hardening the cladding to thereby form the wear-resistant coating and a hardened zone thereof, wherein the hardened zone has a hardness greater than a hardness of the metal substrate.

A wear-resistant coating system includes the metal substrate and the wear-resistant coating disposed on the metal substrate. Further, the wear-resistant coating includes the metal alloy, and has the hardened zone having a hardness greater than a hardness of the metal substrate. Additionally, the wear-resistant coating is substantially resistant to corrosion from sea water at an ambient temperature of from about −40° C. to about 50° C.

In another variation, the wear-resistant coating system includes a steel substrate and the wear-resistant coating disposed on the steel substrate. The wear-resistant coating includes at least one of nickel and chromium and has a thickness of at least 0.025 inch. The wear-resistant coating is substantially resistant to corrosion from sea water at an ambient temperature of from about −40° C. to about 50° C. Additionally, the hardened zone has a thickness of at least 0.005 inch, an average roughness, Rₐ, of from about 2 micro-inches to about 18 micro-inches, and a hardness of from about 392 HV30 to about 698 HV30 on the Vickers hardness scale.

The above features and advantages and other features and advantages of the present invention are readily apparent from the following detailed description of the best modes for carrying out the invention when taken in connection with the accompanying drawings.

### BRIEF DESCRIPTION OF THE DRAWING

FIG. 1 is a schematic magnified cross-sectional view of a wear-resistant coating system including a wear-resistant coating disposed on a metal substrate; and

FIG. 2 is a graphical representation of a relationship between a Vickers hardness and a thickness of the wear-resistant coatings of Examples 1 and 2 and claddings of Comparative Examples 3-5.

### DETAILED DESCRIPTION OF THE EMBODIMENTS

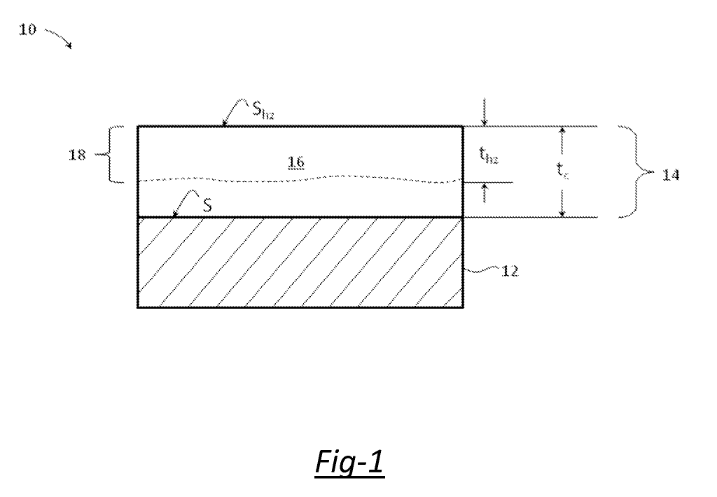

Referring to the Figures, wherein like reference numerals refer to like components, a method of forming a wear-resistant coating on a metal substrate is described herein. The method may be useful for forming a wear-resistant coating system, shown generally at 10 in FIG. 1. The method and wear-resistant coating system 10 may optimize hardness, wear-resistance, and corrosion-resistance of the metal substrate 12, as set forth in more detail below. As such, the method and wear-resistant coating system 10 may be useful for applications such as hydraulic systems and components, e.g., hydraulic cylinders for drilling rig tensioners. However, the method and wear-resistant coating system 10 may also be useful for other applications such as, but not limited to, steel mills, machine tools, and vehicles.

Referring to FIG. 1, the wear-resistant coating system 10 includes the metal substrate 12. The metal substrate 12 may be ferrous, such as a steel substrate, and/or may be formed from, for example, carbon steel, alloy steel, stainless steel, tool steel, cast iron, and combinations thereof In one variation, the metal substrate 12 may be configured as a hydraulic cylinder rod. The hydraulic cylinder rod may have any suitable size according to a desired application. For example, for drilling rig applications, the hydraulic cylinder rod may be configured to translate into and out of a sealed cylinder housing (not shown) and may have a length of from about 40 feet to about 60 feet, and a diameter of from about 5 inches to about 20 inches. Further, the metal substrate 12 may have a surface, shown generally at S, .e.g., when configured as a solid cylinder rod, or may have more than one surface S (not shown), e.g., when configured as a hollow cylinder rod.

Referring again to FIG. 1, the wear-resistant coating system 10 also includes a wear-resistant coating 14 disposed on the metal substrate 12. That is, the wear-resistant coating 14 may be formed on at least one surface S of the metal substrate 12, by the method set forth in more detail below. In particular, the wear-resistant coating 14 may be formed by work hardening a cladding 16, as also set forth in more detail below.

The wear-resistant coating 14 includes a metal alloy. Suitable metal alloys may include an element selected from the group including nickel, cobalt, and combinations thereof. Nickel and/or cobalt may be present in the metal alloy to provide corrosion-resistance to the wear-resistant coating 14. More specifically, nickel and/or cobalt may be present in the metal alloy in an amount of from about 1 part to about 90 parts by weight based on 100 parts by weight of the metal alloy. For example, a suitable nickel-containing metal alloy may include about 65 parts by weight nickel, about 20 parts by weight chromium, about 8 parts by weight molybdenum, about 3.5 parts by weight of a combination of niobium and tantalum, and about 4.5 parts by weight of iron based on 100 parts by weight of the metal alloy, and may be commercially available under the trade name INCONEL® 625 from Special Metals Corporation of New Hartford, N.Y. Likewise, a suitable metal cobalt-containing alloy may include about 54 parts by weight cobalt, about 26 parts by weight chromium, about 9 parts by weight nickel, about 5 parts by weight molybdenum, about 3 parts by weight iron, about 2 parts by weight tungsten, and about 1 part by weight of a combination of manganese, silicon, nitrogen, and carbon, and may be commercially available under the trade name ULTIMET® from Haynes International, Inc. of Kokomo, Ind. Further, other suitable non-limiting examples of metal alloys may include alloys commercially available under the trade names Micro-Melt® CCW alloy from Carpenter Technology Corporation of Reading, Pa., and Stellite® 21 from Stellite Coatings of Goshen, Ind.

Since the metal alloy includes nickel and/or cobalt, the wear-resistant coating 14 exhibits excellent corrosion-resistance. More specifically, the wear-resistant coating 14 is substantially resistant to corrosion from sea water at an ambient temperature of from about −40° C. to about 50° C. Stated differently, the wear-resistant coating 14 minimizes oxidation of the surface S of the metal substrate 12 in air after exposure to sea water. As used herein, in contrast to fresh water, the terminology “sea water” refers to water having a salinity of from about 31 parts by volume to about 40 parts by volume based on 1 trillion parts by volume of sea water, i.e., about 31 ppt to about 40 ppt (about 3.1% to about 4%), and a density of about 1.025 g/ml at 4° C. Further, sea water includes dissolved salts of one or more ions selected from the group including chloride, sodium, sulfate, magnesium, calcium, potassium, bicarbonate, bromide, borate, strontium, fluoride, and combinations thereof. Sea water may include brackish, saline water, and brine.

Additionally, the wear-resistant coating 14 exhibits a free corrosion potential, E_{corr}, of less than or equal to −0.200. As used herein, the terminology “free corrosion potential” refers to the absence of net electrical current flowing to or from the metal substrate 12 in sea water relative to a reference electrode. Further, the wear-resistant coating 14 exhibits a corrosion rate of less than or equal to about 0.010 mils per year (1 mil=0.001 inch). As used herein, the terminology “corrosion rate” refers to a change in the metal substrate 12 and/or wear-resistant coating 14 caused by corrosion per unit of time and is expressed as an increase in corrosion depth per year. Therefore, the wear-resistant coating 14 exhibits minimized susceptibility to localized corrosion from, for example, pitting and/or crack propagation.

Referring again to FIG. 1, the wear-resistant coating 14 includes a hardened zone 18 having a hardness greater than a hardness of the metal substrate 12. In particular, the hardened zone 18 may have a hardness of from about 392 HV30 to about 698 HV30 on a Vickers hardness scale, as measured in accordance with ISO test method 6507-1:2005. For example, the hardened zone 18 may have a hardness of from about 412 HV30 to about 577 HV30 on the Vickers scale and may be formed via the method set forth below. Accordingly, since wear-resistance increases with increasing hardness, the wear-resistant coating 14 exhibits excellent wear-resistance for applications requiring contact with another component, e.g., a hydraulic cylinder seal.

As shown in FIG. 1, the hardened zone 18 also has a surface S_{hz}, and may have an average roughness, Rₐ, of from about 2 micro-inches to about 18 micro-inches, as measured in accordance with ISO test method 4287:1997. As used herein, the terminology “average roughness, Rₐ” refers to a measure of a texture of the surface S_{hz} of the hardened zone 18 and refers to an average distance between peaks and valleys (not shown) of the surface S_{hz}. More specifically, microscopic valleys on the surface S_{hz} of the hardened zone 18 correspond to a point on the surface S_{hz} that lies below an average line. Similarly, microscopic peaks on the surface S_{hz} of the hardened zone 18 correspond to a point on the surface S_{hz} that lies above an average line. Thus, measurements of distances between such peaks and valleys determine the average roughness, Rₐ, of the hardened zone 18. The average roughness, Rₐ, of the hardened zone 18 may be provided by polishing the hardened zone 18, as set forth in more detail below.

Comparatively rougher surfaces generally exhibit less wear-resistance and wear more quickly as compared to relatively smoother surfaces, since irregularities such as peaks and valleys in surfaces may form initiation sites for cracks, stress zones, and/or corrosion. Therefore, since the wear-resistant coating 14 may have an average roughness, Rₐ, of from about 2 micro-inches to about 18 micro-inches, the wear-resistant coating 14 exhibits excellent smoothness and resulting wear- and corrosion-resistance.

Referring again to FIG. 1, the wear-resistant coating 14 may have a thickness, t_{c}, of from about 0.025 inch to about 0.07 inch, e.g., about 0.05 inch. Further, the hardened zone 18 may have a thickness, t_{hz}, of from about 0.001 inch to about 0.07 inch, e.g., about 0.005 inch. That is, although not shown in FIG. 1, it is to be appreciated that the thickness, t_{hz}, of the hardened zone 18 may be equal to the thickness, t_{c}, of the wear-resistant coating 14. Alternatively, as shown in FIG. 1, the thickness, t_{hz}, of the hardened zone 18 may be less than the thickness, t_{c}, of the wear-resistant coating 14 and may be spaced apart from the surface S of the metal substrate 12.

In one variation, the wear-resistant coating system 10 includes the steel substrate 12 and the wear-resistant coating 14 disposed on the steel substrate 12 and including the hardened zone 18. Further, the wear-resistant coating 14 includes at least one of nickel and chromium and has a thickness, t_{c}, of at least 0.025 inch. The wear-resistant coating 14 is substantially resistant to corrosion from sea water at an ambient temperature of from about −40° C. to about 50° C. Further, the hardened zone 18 has a thickness, t_{hz}, of at least 0.005 inch, an average roughness, Rₐ, of from about 2 micro-inches to about 18 micro-inches, and a hardness of from about 392 HV30 to about 698 HV30 on the Vickers hardness scale. For example, the hardened zone 18 may have a hardness of from about 415 HV30 to about 485 HV30 on the Vickers hardness scale.

The method of forming the wear-resistant coating 14 on the metal substrate 12 is described with general reference to FIG. 1. The method includes depositing the metal alloy onto the metal substrate 12 to form the cladding 16. The metal alloy may be deposited onto the metal substrate 12 by any known process. For example, the method may include laser cladding or plasma transfer arc cladding the metal substrate 12 with the metal alloy. In particular, the metal alloy may be provided in powder form and may be laser clad or plasma arc clad onto the metal substrate 12 to form the cladding 16. Laser cladding may include melting and consolidating the metal alloy onto the metal substrate 12 via a laser. Plasma transfer arc cladding may include high energy, inert gas-welding the metal alloy onto the metal substrate 12. After laser cladding or plasma transfer arc cladding, the metal alloy may be deposited onto the metal substrate 12 so that the metal alloy bonds to the metal substrate 12 to form the cladding 16.

The method further includes rough finishing the cladding 16 to thereby provide the cladding 16 with an average roughness, Rₐ, of from about 50 micro-inches to about 150 micro-inches, e.g., from about 60 micro-inches to about 125 micro-inches. The cladding 16 is rough finished to the aforementioned average roughness, Rₐ, to prepare the cladding 16 for subsequent processing, as set forth in more detail below. The cladding 16 may be rough finished by any suitable process. For example, rough finishing may be selected from the group including machining, grinding, polishing, and combinations thereof. As a non-limiting example, the cladding 16 may be rough finished by a grinding apparatus, such as a lathe.

It is to be appreciated that the terminology “cladding 16” refers to the precursor to the wear-resistant coating 14, i.e., to a layer deposited onto the metal substrate 12 prior to formation of the hardened zone 18. That is, in contrast to the wear-resistant coating 14 including the hardened zone 18, the cladding 16 is comparatively softer and less wear-resistant than the wear-resistant coating 14.

Referring again to FIG. 1, the method also includes work hardening the cladding 16 to thereby form the wear-resistant coating 14 and the hardened zone 18 thereof, wherein the hardened zone 18 has a hardness greater than a hardness of the metal substrate 12. That is, the hardened zone 18 may have a hardness of from about 392 HV30 to about 698 HV30, e.g., from about 412 HV30 to about 577 HV30, on the Vickers hardness scale. That is, work hardening may plastically deform the cladding 16 to thereby form the hardened zone 18. The cladding 16 may be work hardened by any suitable process that produces a controlled amount of plastic deformation in the cladding 16 without cracking the cladding 16. For example, the cladding 16 may be work hardened by processes such as, but not limited to, roller burnishing, low plasticity burnishing (LBP), flow forming, draw forming, shot peening, polymer lapping, equal channel angular pressing (ECAP), electromagnetic shock forming, extrusion, cold forming, cold rolling, drawing, and combinations thereof

By way of one non-limiting example, work hardening may include roller burnishing the cladding 16 with at least one non-ferrous roller to thereby form the hardened zone 18. For example, work hardening may include roller burnishing the cladding 16 with one non-ferrous roller or a plurality of non-ferrous rollers. The hardened zone 18 may have a hardness of about 458 HV30 on the Vickers scale, and the hardened zone 18 may have a thickness, t_{hz}, of about 0.005 inch. Alternatively, the hardened zone 18 may have a thickness, t_{hz}, equal to substantially the entire thickness, t_{c}, of the cladding 16, e.g., about 0.05 inch. The cladding 16 may be roller burnished by two or more ceramic rollers to thereby plastically deform the cladding 16, without cracking the cladding 16, to form the hardened zone 18. The cladding 16 may be roller burnished by non-ferrous rollers to prevent iron particles from embedding in the cladding 16 and degrading the corrosion-resistance of the cladding 16.

Work hardening may also provide the hardened zone 18 with an average roughness, Rₐ, of from about 2 micro-inches to about 18 micro-inches. That is, work hardening may provide the hardened zone 18 of the wear-resistant coating 14 with a smooth surface S_{hz} and excellent surface bearing ratios.

Alternatively, the method may further include polishing the wear-resistant coating 14 after work hardening to provide the hardened zone 18 with an average roughness, Rₐ, of from about 2 micro-inches to about 18 micro-inches. The wear-resistant coating 14 may be polished by, for example, a grinding device or polisher.

It is to be appreciated that rough finishing and work hardening, e.g., roller burnishing, may be performed on the same apparatus. For example, to minimize production time, roller burnishing may be performed immediately after rough finishing the cladding 16. That is, a hydraulic cylinder rod having a length of 50 feet may be laser clad with the metal alloy to form the cladding 16. The clad hydraulic cylinder rod may then be mounted in a lathe. After the lathe has rough finished about a 2 linear-foot portion of the cladding 16, roller burnishing may begin on the rough finished portion of the cladding 16. Likewise, after the 2 linear-foot portion of the cladding 16 has been work hardened by roller burnishing, the hardened zone 18 may be polished to provide the hardened zone with the final average roughness, Rₐ, of from about 2 micro-inches to about 18 micro-inches.

In this variation, the hardened zone 18 of the wear-resistant coating 14 may be polished by, for example, a plurality of polishers that operate sequentially on the wear-resistant coating 14. Also, for the method, the hydraulic cylinder rod may be steadied by supports configured to dampen vibrations and thereby protect the smooth surface S_{hz} during rough finishing and work hardening of the cladding 16, and during any polishing of the wear-resistant coating 14. The aforementioned method for forming the wear-resistant coating 14 on the metal substrate 12 is cost-effective since throughput may be increased by immediately work hardening prior-rough finished portions of the hydraulic cylinder rod.

Work hardening the cladding 16 after rough finishing to form the wear-resistant coating 14 provides a hard, wear-resistant coating 14. Further, work hardening the cladding 16 after rough finishing provides the wear-resistant coating 14 with excellent corrosion-resistance since the controlled plastic deformation of work hardening seals, i.e., smears over, any surface discontinuities such as pores or cracks. Work hardening also provides the wear-resistant coating 14 with compressive residual stress that inhibits initiation and propagation of surface defects and increases a tolerance of the wear-resistant coating system 10 to tensile loads. Moreover, the compressive residual strength of the wear-resistant coating 14 increases fatigue strength of the metal substrate 12 due to the minimization of discontinuities and stress risers in the wear-resistant coating 14.

The wear-resistant coating systems 10 and related methods provide wear-resistant coatings 14 having excellent hardness and corrosion-resistance. Therefore, the wear-resistant coating systems 10 are suitable for exposure to sea water, e.g., for applications requiring coated metal substrates 12 for operation within a splash-zone of an offshore drilling rig. The wear-resistant coatings 14 are smooth and exhibit excellent compressive residual stress. Therefore, the wear-resistant coating systems 10 exhibit improved fatigue life and resistance to tensile stress, and reduced infiltration and propagation of fatigue cracks, shrink cracks, and other flaws. Further, the methods are cost-effective, and minimize discontinuities in the wear-resistant coatings 14 such as cracks and/or pores in the hardened zone 18.

The following examples are meant to illustrate the invention and are not to be viewed in any way as limiting to the scope of the invention.

### EXAMPLES

### Example 1

In preparation for forming a wear-resistant coating of Example 1 on a steel hydraulic cylinder rod having a length of 50 feet and a diameter of 10 inches, INCONEL® 625 metal alloy in powder form is loaded to a laser cladding apparatus. The laser cladding apparatus deposits the INCONEL® 625 metal alloy onto the steel hydraulic cylinder rod to form a cladding having a thickness of 0.05 inch.

The cladding is then rough finished by a grinding apparatus to thereby provide the cladding with an average roughness, Rₐ, of 100 micro-inches.

After rough finishing, the cladding is roller burnished by two ceramic rollers to thereby form the wear-resistant coating of Example 1. The wear-resistant coating of Example 1 includes a hardened zone having a thickness of 0.025 inch.

### Example 2

In preparation for forming a wear-resistant coating of Example 2 on a steel hydraulic cylinder rod having a length of 50 feet and a diameter of 10 inches, INCONEL® 625 metal alloy in powder form is loaded to a laser cladding apparatus. The laser cladding apparatus deposits the INCONEL® 625 metal alloy onto the steel hydraulic cylinder rod to form a cladding having a thickness of 0.05 inch.

The cladding is then rough finished by a grinding apparatus to thereby provide the cladding with an average roughness, Rₐ, of 100 micro-inches.

After rough finishing, the cladding is roller burnished by two ceramic rollers to thereby form the wear-resistant coating of Example 2. The wear-resistant coating of Example 2 includes a hardened zone having a thickness of 0.015 inch.

### Comparative Examples 3-5

In preparation for forming a cladding of each of Comparative Examples 3-5, INCONEL® 625 metal alloy in powder form is loaded to a laser cladding apparatus. The laser cladding apparatus deposits the INCONEL® 625 metal alloy onto each of three steel hydraulic cylinder rods, each having a length of 50 feet and a diameter of 10 inches, to form the claddings of each of Comparative Examples 3-5. Each of the claddings of Comparative Examples 3-5 has a thickness of 0.05 inch.

Thereafter, each cladding is not rough finished by a grinding apparatus, and each cladding is not work hardened by roller burnishing.

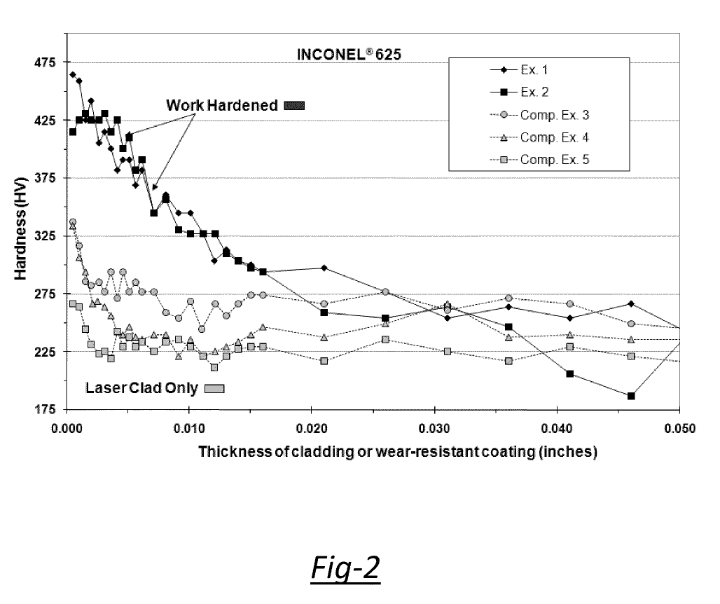

The wear-resistant coatings of each of Examples 1 and 2 and the claddings of each of Comparative Examples 3-5 are evaluated for hardness at various thicknesses in accordance with ISO test method 6507-1:2005, and assigned a Vickers hardness, HV30, on a Vickers hardness scale. The results of the hardness evaluations are summarized in FIG. 2.

As evidenced by the comparative data set forth in FIG. 2, the wear-resistant coatings of Examples 1 and 2 exhibit increased hardness as compared to each of the claddings of Comparative Examples 3-5. In particular, the wear-resistant coating of Example 1 has a hardness of 465 HV30 at a surface of the hardened zone, and the wear-resistant coating of Example 2 has a hardness of 415 HV30 at a surface of the hardened zone. In contrast, the claddings of each of Comparative Examples 3-5 have a hardness of 335 HV30, 334 HV30, and 265 HV30, respectively, and do not include a hardened zone.

Therefore, with reference to FIG. 2, work hardening the claddings of each of Examples 1 and 2 forms the respective hardened zones. As shown in FIG. 2, the work hardening of Examples 1 and 2 forms a hardened zone having a thickness of at least 0.015 inch. By comparison, the claddings of Comparative Examples 3-5 do not include a hardened zone, and the hardness of the claddings sharply decreases at a cladding thickness of about 0.005 inch.

Additionally, the wear-resistant coatings of each of Examples 1 and 2 and the claddings of each of Comparative Examples 3-5 are also evaluated for free corrosion potential by subjecting the coated and/or clad hydraulic cylinder rods to sea water and measuring the presence or absence of net electrical current flowing to or from each of the hydraulic cylinder rods relative to a reference electrode. Each of the wear-resistant coatings of Examples 1 and 2 and each of the claddings of Comparative Examples 3-5 has a free corrosion potential, E_{corr}, of less than or equal to −0.200.

Further, the wear-resistant coatings of each of Examples 1 and 2 and the claddings of each of Comparative Examples 3-5 are also evaluated for corrosion rate by subjecting the coated and/or clad hydraulic cylinder rods to sea water at an ambient temperature of 10° C. for 24 hours and measuring any change in the hydraulic cylinder rods, wear-resistant coatings, and/or claddings. Corrosion rate per year is then calculated for each sample. Each of the wear-resistant coatings of Examples 1 and 2 and each of the claddings of Comparative Examples 3-5 has a corrosion rate of less than or equal to 0.010 mils per year.

Therefore, the wear-resistant coatings of Examples 1 and 2 exhibit excellent corrosion-resistance, even while having excellent hardness. And, work hardening to form the wear-resistant coatings of each of Examples 1 and 2 does not decrease corrosion-resistance. Rather, work hardening provides the wear-resistant coatings of Examples 1 and 2 with a combination of excellent hardness, wear-resistance, and corrosion-resistance.

While the best modes for carrying out the invention have been described in detail, those familiar with the art to which this invention relates will recognize various alternative designs and embodiments for practicing the invention within the scope of the appended claims.

1. A method of forming a wear-resistant coating on a metal substrate, the method comprising:
depositing a metal alloy onto the metal substrate to form a cladding;
rough finishing the cladding to thereby provide the cladding with an average roughness, Rₐ, of from about 50 micro-inches to about 150 micro-inches; and
work hardening the cladding to thereby form the wear-resistant coating and a hardened zone thereof, wherein the hardened zone has a hardness greater than a hardness of the metal substrate.

2. The method of claim 1, wherein work hardening plastically deforms the cladding to thereby form the hardened zone.

3. The method of claim 2, wherein work hardening is further defined as roller burnishing the cladding with at least one non-ferrous roller to thereby form the hardened zone.

4. The method of claim 1, wherein work hardening forms the hardened zone having a hardness of from about 392 HV30 to about 698 HV30 on the Vickers hardness scale.

5. The method of claim 1, wherein depositing is further defined as laser cladding the metal substrate with the metal alloy in powder form to form the cladding.

6. The method of claim 1, wherein depositing is further defined as plasma transfer arc cladding the metal substrate with the metal alloy in powder form to form the cladding.

7. The method of claim 1, wherein rough finishing is selected from the group including machining, grinding, polishing, and combinations thereof

8. The method of claim 1, further including polishing the wear-resistant coating after work hardening to provide the hardened zone with an average roughness, Rₐ, of from about 2 micro-inches to about 18 micro-inches.

9. A wear-resistant coating system comprising:
a metal substrate; and
a wear-resistant coating disposed on the metal substrate and including a metal alloy;
wherein the wear-resistant coating is substantially resistant to corrosion from sea water at an ambient temperature of from about −40° C. to about 50° C.;
wherein the wear-resistant coating includes a hardened zone having a hardness greater than a hardness of the metal substrate.

10. The wear-resistant coating system of claim 9, wherein the wear-resistant coating has a thickness of from about 0.025 inch to about 0.07 inch.

11. The wear-resistant coating system of claim 10, wherein the hardened zone has a thickness of from about 0.001 inch to about 0.07 inch.

12. The wear-resistant coating system of claim 9, wherein the hardened zone has an average roughness, Rₐ, of from about 2 micro-inches to about 18 micro-inches.

13. The wear-resistant coating system of claim 9, wherein the metal alloy includes an element selected from the group including nickel, cobalt, and combinations thereof.

14. The wear-resistant coating system of claim 9, wherein the metal substrate is ferrous.

15. A wear-resistant coating system comprising:
a steel substrate; and
a wear-resistant coating including a hardened zone and disposed on the steel substrate;
wherein the wear-resistant coating includes at least one of nickel and chromium and has a thickness of at least 0.025 inch;
wherein the wear-resistant coating is substantially resistant to corrosion from sea water at an ambient temperature of from about −40° C. to about 50° C.;
wherein the hardened zone has a thickness of at least 0.005 inch, an average roughness, Rₐ, of from about 2 micro-inches to about 18 micro-inches, and a hardness of from about 392 HV30 to about 698 HV30 on a Vickers hardness scale.
